(19) United States
(12) Patent Application Publication
(10) Pub. No.: US 2003/0129965 A1
(43) Pub. Date: Jul. 10, 2003

(54) Configuration management system and method used to configure a biometric authentication-enabled device

(76) Inventor: William G. Siegel, Wellington, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/284,436

(22) Filed: Oct. 31, 2002

Related U.S. Application Data
(60) Provisional application No. 60/330,794, filed on Oct. 31, 2001.

(51) Int. Cl. H04M 1/66

(52) U.S. Cl. 455/411

(57) ABSTRACT

The present invention relates to systems and methods for configuration management of biometric authentication-enabled devices. A biometric authentication-enabled device may be any of a wide range of configurable devices, such as a mobile telephone, a personal data assistant, or an automobile that has been coupled to or integrated with an identification device used to authenticate a user's identity. The methods for configuration management include verifying user identity through user-provided configuration information, such as passwords or other identification codes, authenticating an individual based on biometric information obtained from the individual, and configuring a device based on user-provided configuration and biometric information.

### RELATED APPLICATIONS

This application claims priority under 35 U.S.C. §119(e) to U.S. Provisional Application Ser. No. 60/330,794 (the '794 Prov. App.), filed Oct. 31, 2001, which is incorporated herein by reference in its entirety.

### FIELD OF THE INVENTION

The present invention relates generally to the use of identification devices to authenticate individuals. More particularly, it relates to a configuration management system and method to configure a biometric authentication enabled-device.

### BACKGROUND OF THE INVENTION

Electronic devices used and relied upon by consumers, business and government have proliferated over the last decade. These devices range from mobile telephones to electronic personal data assistants to automobiles that contain many sophisticated computer systems controlling everything from the ignition switch to on-board navigation systems. While the proliferation has been impressive and provided significant benefits, security concerns limit the growth of electronic devices and services that could be implemented through the use of an electronic device.

As the use of electronic devices has proliferated, so has misuse of these devices. One of the more common misuses of electronic devices is the unauthorized use of a mobile telephone by another person. Such unauthorized use results in significant costs to both consumers and wireless service providers. Additionally, criminals and terrorists often misuse electronic devices that may have been obtained with a false identification or used without a trace to further their crimes or terrorist acts. Moreover, the potential for misuse and fraud, also limits the introduction of innovative services that rely upon electronic devices.

Biometrics are a group of technologies that provide a high level of security. Fingerprint capture and recognition is an important biometric technology. Law enforcement, banking, voting, and other industries increasingly rely upon fingerprints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

The use of biometrics provides an opportunity to address these security concerns associated with electronic devices, reduce the costs associated with fraudulent activities, and to further the proliferation of electronic devices to simplify everyday life. Specifically, to realize the potential benefits of using biometric information to address these security issues, devices can be configured based on a biometric that is unique to a particular user. In this way, unauthorized use can be reduced. Additionally, when a criminal or terrorists uses an electronic device that requires biometric information to be configured for use. If that device is used to further a crime or terrorist act an audit trail can be created that uniquely traces the use of an electronic device to a terrorist or criminal. Such an approach would provide an invaluable tool to law enforcement. To ensure the integrity of identity authentication based on biometrics, configuration management methods will need to be robust, easily incorporated into electronic devices and not create security vulnerabilities.

What is needed is a method for configuration management that enables the use of biometric authentication in a wide range of devices that is secure, adaptable to the particular device, and cost effective.

### BRIEF SUMMARY OF THE INVENTION

Embodiments of the present invention provide systems and methods related to configuration management of biometric authentication-enabled devices. A biometric authentication-enabled device may be any of a wide range of configurable devices, such as a mobile telephone, a personal data assistant, or an automobile, that has been coupled to an identification device, such as a biometric print device, used to authenticate a user's identity.

The present invention provides a biometric authentication-enabled system by coupling or integrating an identification device to a configurable device. Upon being coupled with the identification device, a configurable device may be referred to as a biometric authentication enabled-device. In one embodiment of the biometric authentication-enabled system, a piezoelectric identification device is wirelessly coupled to a configurable device. In another embodiment of the biometric authentication-enabled system, a piezoelectric identification device is integrated within the configurable device.

The methods for configuration management include verifying user identity through user-provided configuration information, such as passwords or other identification codes, authenticating an individual based on biometric information obtained from the individual through the use of a biometric authentication-enabled device and providing configuration information for the device based on user-provided configuration information and biometric information.

The present invention will enable a wide range of new consumer services that provide added security and privacy. In particular, the present invention enables service providers to securely configure electronic devices based on biometric information. For example, a service provider offering mobile telephone service might provide mobile telephones that have been upgraded to enable biometric authentication. Through use of the mobile telephones that are biometric authentication-enabled devices, the service provider can guarantee higher levels of security to reduce fraud and also provide specific configuration information for the phone that may include calling plans based on the particular biometric information that is received.

The present invention may also be used to enhance services or processes that currently do not use a configurable device, but require strict security. One such example is the use of the present invention to support aspects of electronic airline ticketing to enhance security and improve efficiency. For example, today a traveler boarding an airplane must typically provide to a gate agent his or her boarding pass and display a photo identification. This process is often slow and cumbersome, and prone to human error. With the present invention, a traveler could be provided a small biometric authentication-enabled device by the airline at check-in (or it could be the traveler's own personal data assistant device) that contains the traveler's flight information. As the traveler boarded the plane, the device could transmit the traveler's boarding information and biometric data, such as fingerprint information. This would eliminate the possibility of human error by the gate agent reviewing photo identification and accelerate the boarding process.

When using the configuration methods of the present invention, services can be secured such that only an authorized user can use the particular device associated with a service. Additionally, the present invention provides a non-refutable, traceable configuration process to conclusively determine who was using a particular device. This benefit of the present invention offers significant benefits to law enforcement officers that may desire to determine who used a mobile telephone (and to have that determination stand in court). With the present invention, an audit trail can be established that associates a unique biometric characteristic with the use of a mobile telephone. Other benefits of the present invention include enabling a wide range of devices to have biometric authentication capabilities including small, mobile devices, such as mobile telephones, personal data assistants, and electronic wallets.

Further embodiments, features, and advantages of the present invention as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 illustrates a configuration management system using biometric authentication according to an embodiment of the invention.

FIG. 8 illustrates a method for configuration management using biometric authentication according to an embodiment of the invention.

FIG. 9 illustrates a method for verifying configuration information according to an embodiment of the invention.

FIG. 10 illustrates a method for authenticating biometric information used to configure a biometric authentication-enabled device according to an embodiment of the invention.

FIG. 11 illustrates a method for providing biometric information used to configure a biometric authentication-enabled device according to an embodiment of the invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

The present invention relates to systems and methods for configuration management of biometric authentication-enabled devices. A biometric authentication-enabled device may be any of a wide range of configurable devices, such as a mobile telephone, a personal data assistant, or an automobile, that has been coupled to an identification device, such as a biometric print device, used to authenticate a user's identity.

The present invention provides a biometric authentication-enabled system by coupling or integrating an identification device to a configurable device. Upon being coupled with the identification device, a configurable device may be referred to as a biometric authentication enabled-device.

The methods for configuration management include verifying user identity through general configuration information, such as passwords or other identification codes; authenticating an individual based on biometric information obtained from the individual and providing configuration information based on the configuration information and biometric information.

The present invention relates generally to a piezoelectric identification device and applications thereof. More particularly, it relates to a piezoelectric device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as a one-to-one process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee whose template was matched.

II. Wireless Transceiver Biometric Devices

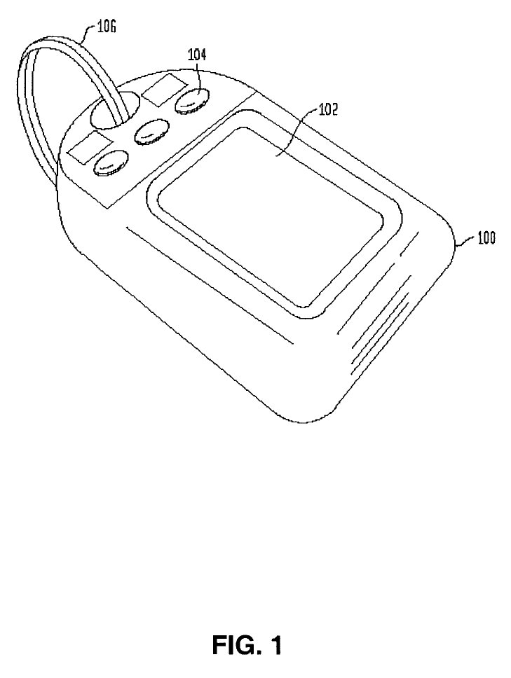

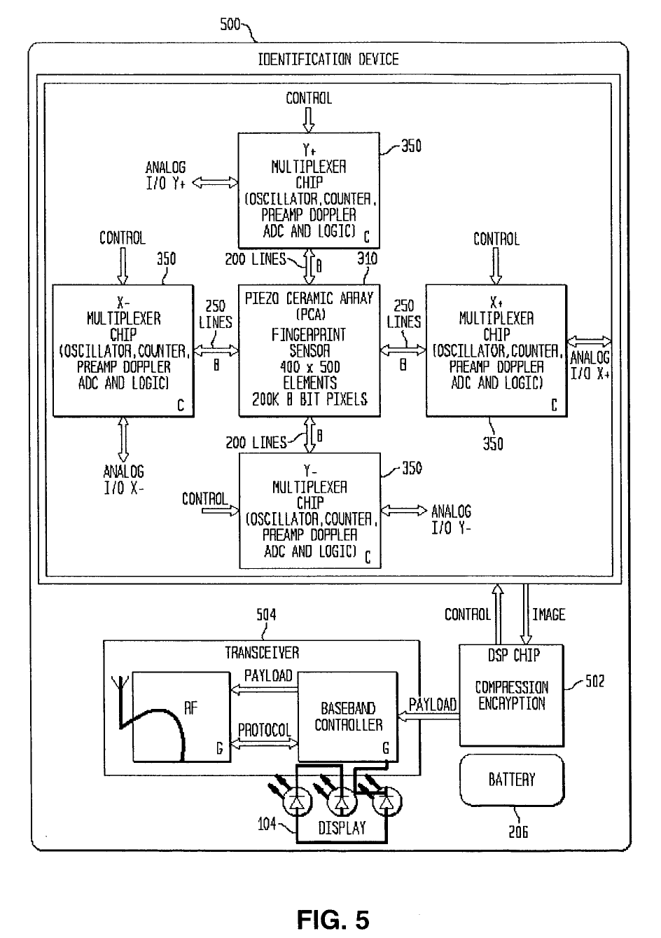

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

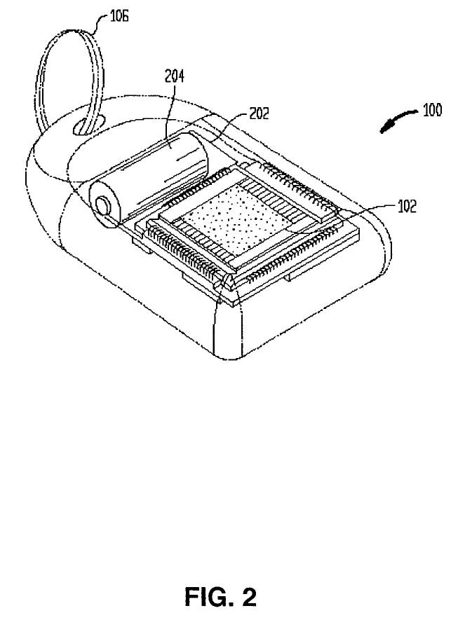

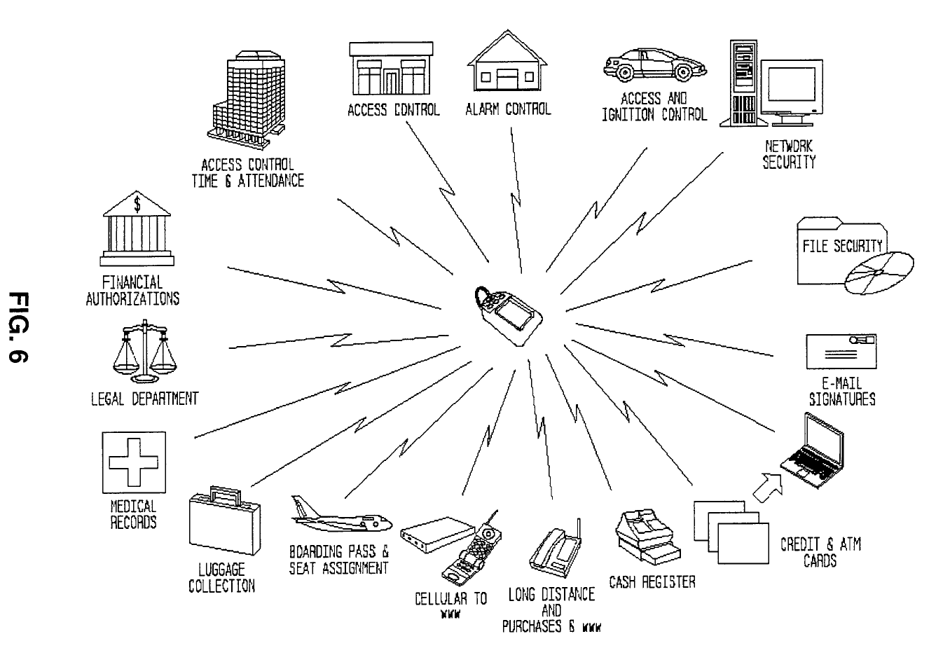

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-9.

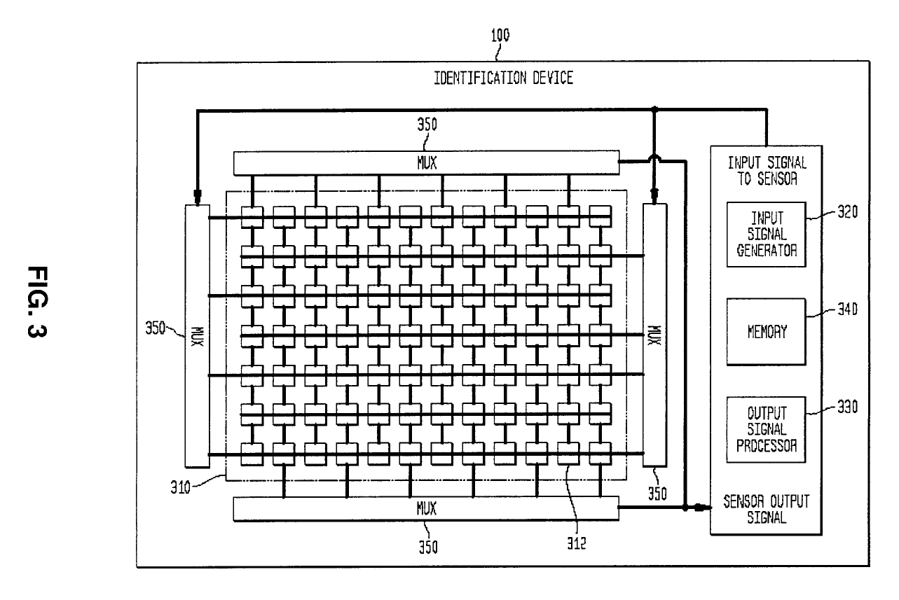

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the No. 60/330,794 Prov. App, which is incorporated by reference herein in its entirety.

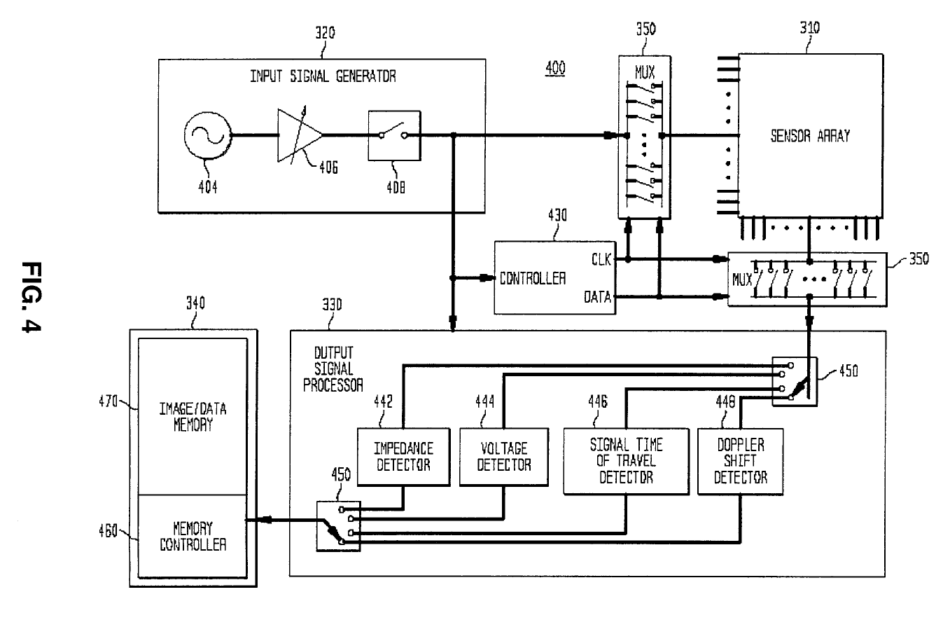

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. 60/330,794, which is incorporated by reference herein in its entirety.

### III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400,and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Methods for Configuration Management

As discussed above, wireless transceiver biometric devices may be used in a plethora of applications. The effective use of a biometric authentication-enabled device that incorporates the functionality of an identification device, such as in the wireless transceiver biometric device described above, requires methods to configure the biometric authentication-enabled device. These methods must be cost efficient, and must not impair the integrity of the security inherent with the the unique characteristics associated with the biometric information being used.

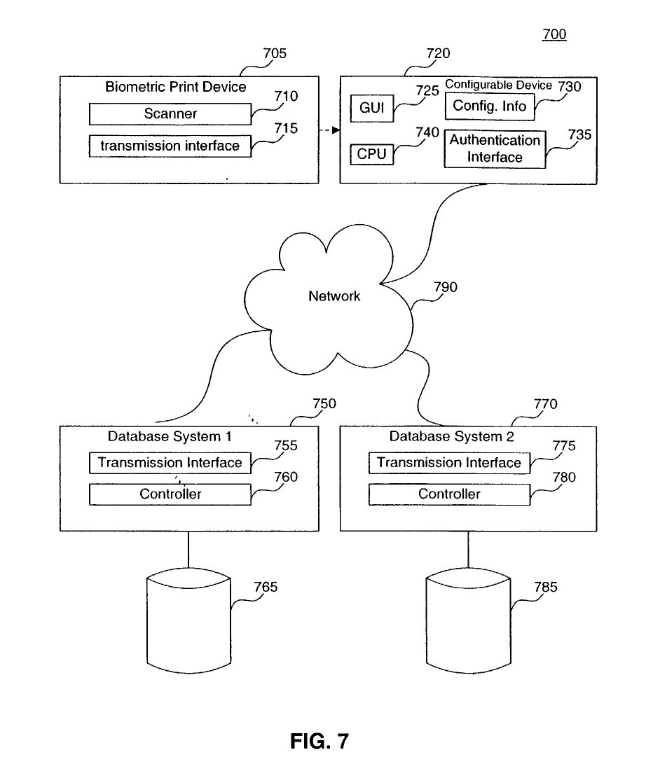

FIG. 7 illustrates configuration management system 700, according to an embodiment of the present invention. Configuration management system 700, comprises biometric print device 705, configurable device 720, first database system 750, second database system 770, and network 790. Biometric print device 705 further comprises scanner 710 and transmission interface 715. Biometric print device 705 may be wireless transceiver biometric device 100, 400, or 500 or some other form of identification device (e.g., devices using silicon capacitive sensor technology) that captures any of a wide range of biometric information including, but not limited to fingerprints, palmprints, or supplemental biometric information that further characterizes an individual's state, such as vital signs (e.g. blood flow).

Configurable device 720 further comprises GUI interface 725, central processing unit 740, memory device 730, and authentication interface 735. Configurable device 720 may be a wide variety of electronic devices, including but not limited to, a mobile telephone, a personal data assistant, an electronic wallet and a human transportation vehicle. As used herein, mobile telephone refers to, but is not limited to, a cellular telephone, a personal communication system (PCS) wireless telephone or a satellite telephone. Additionally, a human transportation vehicle refers to, but is not limited to, an automobile, a truck, an aircraft, a motorcycle or a motor scooter.

Database system 750 further comprises transmission interface 755, controller interface 760 and database 765. Database system 770 comprises similar elements as shown.

Biometric print device 705 is coupled to configurable device 720. The coupling may be electronic, wireless or biometric print device 705 may be integrated into configurable device 720. Biometric print device 705 provides biometric information obtained from an individual to configurable device 720 through the coupling. Configurable device 720 uses authentication interface 735 to transmit the biometric information across a network to a database system, such as database system 750 or database system 770 for authentication.

Network 790 may be connected to configurable device 720 and the database systems through any number of means, such as wirelessly, that will be known to individuals skilled in the relevant art(s). Key characteristics of the channel through network 790 are that it must be reliable and secure. Network 790 may be either public (e.g., through the use of a virtual private network (VPN) tunnel connection) or private.

Database system 750 and database system 770 manage three types of data. One type of data is biometric data. The biometric data consists of biometric information obtained from individuals that have subscribed to a service. The second type of data consists of user-provided configuration information, such as personal identification numbers and other types of passwords. The third type of data consists of device configuration files.

Device configuration files contain detailed instructions on how to configure a device for a specific service based on the user-provided configuration information and biometric information. For example, a configuration file for a mobile telephone may contain information that configures a mobile telephone to permit calls within the United States, but deny calls placed outside of the United States. In another example, a device configuration file may contain information that permits an individual to operate an auto, provided that the same individual transmits, every five minutes, handprint information that is obtained from the auto's steering wheel while the auto is moving. This type of configuration file may be used with rental cars. It may also be used with flex cars used in emerging commuter services. Flex cars are made available within a city area to many different commuters who use public transportation to get into the city, but may want to have access to a flex car for brief periods of time during the day.

In one embodiment, database system 750 maintains user-provided configuration information and configuration files, while database system 770 maintains biometric information. The types of data can be maintained in any combination in the database systems, and also can be contained in a single database system.

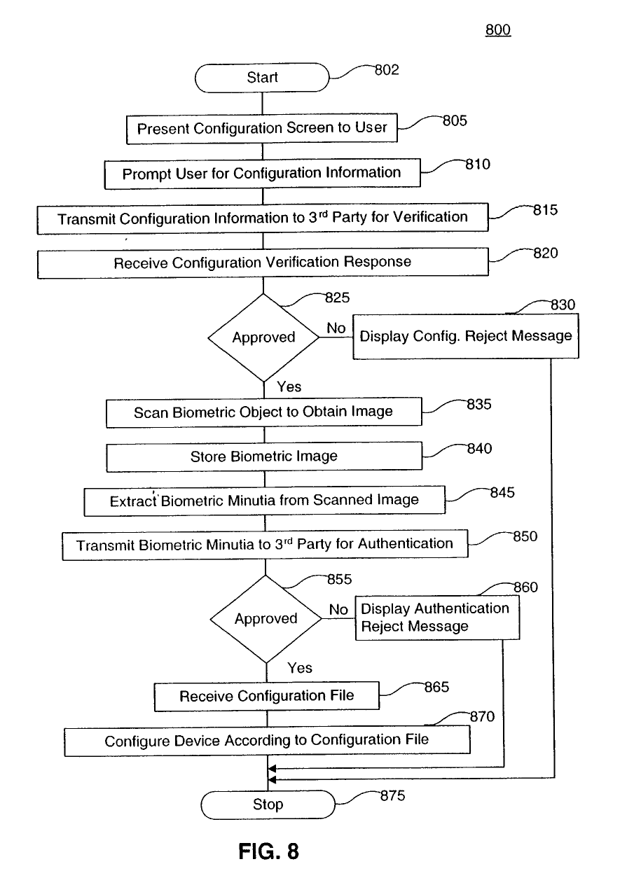

FIG. 8 illustrates method 800 for managing the configuration of a biometric authentication-enabled device, according to an embodiment of the present invention. The method begins in step 802. In step 805, a configurable device, such as configurable device 720, presents a configuration screen to a user. In step 810, configurable device 720 requests through the configuration screen that the user provide configuration information, such as a personal identification number. In another embodiment, a configurable device may provide an audible prompt requesting the user to provide configuration information. Upon receipt of the configuration information from the user, configurable device 720 transmits the user-provided configuration information for verification. In one embodiment, the information will be transmitted over network 790 and will be received by either database system 750 or database system 770.

In step 820, configurable device 720 receives a configuration verification response that identifies whether the user-provided configuration information was approved. In step 825, configurable device 720 determines whether the user-provided configuration information was approved. If the information was not approved, in step 830 configurable device 720 displays a reject message and terminates the process of configuring configurable device 720 in step 875. In this case, the individual's access and use is denied. If the information is approved, configurable device 720 proceeds to step 835.

In step 835, a biometric print device (e.g., biometric print device 705) scans a biometric object to obtain an image. Within this step, configurable device 720 prompts the user to place a biometric object, for example, a finger on scanner 710. The user then places the biometric object on a scanner, such as scanner 710, and an image of a fingerprint is obtained, or in other words captured. In step 840, biometric print device 705 stores all or a portion of the captured biometric image. In step 845, biometric print device 705 extracts biometric minutia from the scanned image. This step exists to ensure efficient data transmission of the captured biometric image. For example, with a fingerprint only certain points of the fingerprint are necessary to uniquely identify an individual. Thus, it would be potentially wasteful to transmit data for the entire fingerprint. In step 850, configurable device 720 transmits the biometric minutia from the captured biometric image for authentication. In one embodiment, the information will be transmitted over network 790 and will be received by either database system 750 or database system 770.

In step 855, configurable device 720 receives a biometric verification response and determines whether the biometric information was approved. If the information was not approved, in step 860 configurable device 720 displays a reject message and terminates the process of configuring electronic configurable device 720 in step 875. In this case, the individual's access and use is denied. If the information is approved, configurable device 720 proceeds to step 865. In step 865, configurable device 720 receives a device configuration file that provides instructions on how the device should be configured based on the user-provided configuration information and the biometric information. In step 870, configurable device 720 configures itself according to the device configuration file. The method 800 ends in step 875. Once configured, configurable device 720 may be used by an individual according to the information contained in the configuration file.

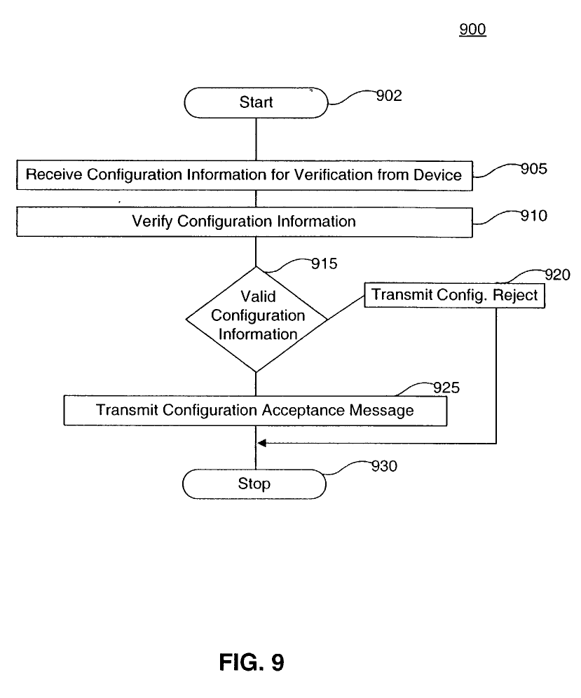

FIG. 9 illustrates method 900 for verifying user-provided configuration information, according to an embodiment of the present invention. The process begins in step 902. In step 905, user-provided configuration information is received from a configurable device, such as configurable device 720. In step 910, the received user-provided configuration information is verified. In step 915, a determination is made whether the user-provided configuration information is valid. If the information is not valid, then in step 920 a rejection message is sent to configurable device 720 and the method stops at step 930. If the user-provided configuration information is valid, then in step 925, a configuration acceptance message is transmitted to configurable device 720. The method then stops in step 930.

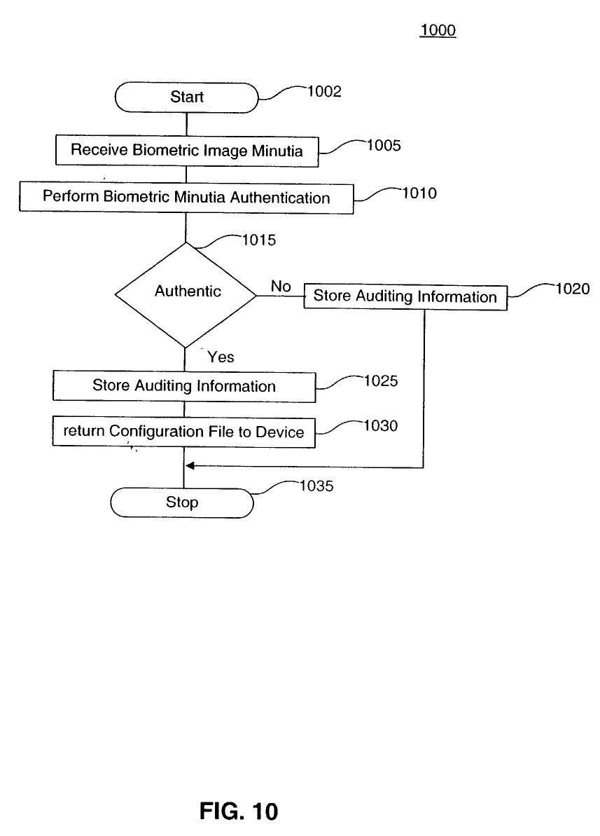

FIG. 10 illustrates method 1000 for performing biometric data authentication, according to an embodiment of the present invention. The method starts in step 1002. In step 1005, a biometric image or biometric image minutia is received from a configurable device, such as configurable device 720. In step 1010, biometric minutia authentication is performed. In step 1015, a determination is made wether the biometric minutia is authentic. If the biometric minutia is not authentic, then in step 1020 auditing information is stored and the method is stopped in step 1035. If the biometric minutia is authentic, then the method proceeds to step 1025. In step 1025 auditing information is stored. In step 1030, a configuration file is transmitted to electronic configurable device 720. In step 1035, the method stops.

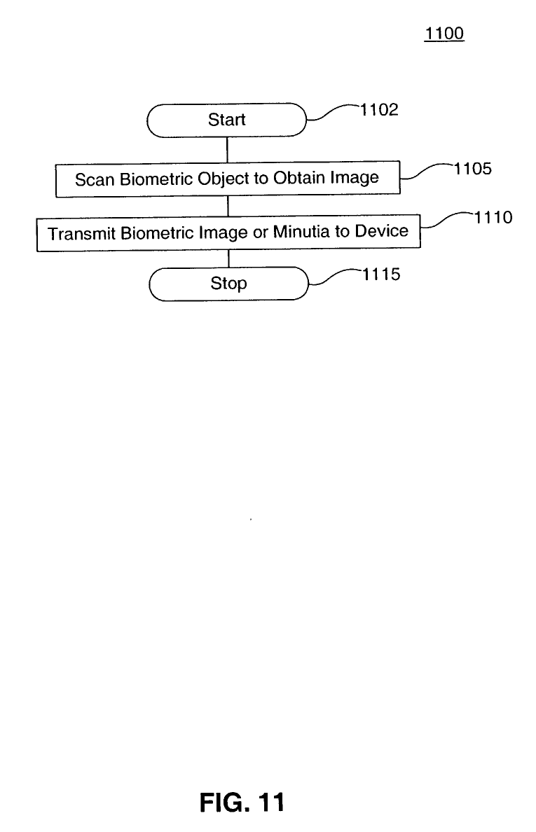

FIG. 11 illustrates method 1100 for obtaining biometric data, according to an embodiment of the present invention. In step 1100, the process starts. In step 1105, a biometric object is scanned to obtain a biometric image. In step 1110 a biometric image or minutia is transmitted to a configurable device, such as configurable device 720. In step 1115, the method stops.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

Conclusion

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method for controlling the use of a configurable device, comprising;
a. receiving a request to configure the configurable device for use by an individual;
b. processing the request to verify whether the individual is authorized to use the configurable device;
c. if the individual is authorized to use the configurable device, sending the individual a request to verify the identity of the individual using a biometric print device coupled to the configurable device;
d. receiving data regarding the identity of the individual; and
e. sending a configuration file to the configurable device that provides information to configure the configurable device for use by the individual.

2. The method of claim 1, wherein the configurable device is a mobile telephone.

3. The method of claim 1, wherein the configurable device is a human transportation vehicle.

4. The method of claim 1, wherein the request processed in step (b) contains a personal identification number.

5. The method of claim 1, wherein the request processed in step (b) contains a password.

6. The method of claim 1, wherein the request processed in step (b) contains a national identity number.

7. The method of claim 1, wherein the biometric print device in step (c) is a piezoelectric identification device.

8. The method of claim 1, wherein the biometric print device in step (c) is a wireless transceiver biometric device.

9. The method of claim 1, wherein the data received in step (d) contains a biometric print.

10. The method of claim 9, wherein the biometric print is a portion of a fingerprint.

11. The method of claim 9, wherein the biometric print is a portion of a handprint.

12. A method for controlling the use of a configurable device by an individual, comprising;
a. requesting the individual to verify the identity of the individual using a biometric print device coupled to the configurable device;
b. receiving data regarding the identity of the individual; and
c. sending a configuration file to the configurable device that provides information to configure the configurable device for use by the individual.

13. The method of claim 12, wherein the configurable device is a mobile telephone.

14. The method of claim 12, wherein the configurable device is a human transportation vehicle.

15. The method of claim 12, wherein the biometric print device in step (c) is a piezoelectric identification device.

16. The method of claim 12, wherein the biometric print device in step (c) is a wireless transceiver biometric device.

17. The method of claim 12, wherein the data received in step (d) contains a biometric print.

18. The method of claim 17, wherein the biometric print is a portion of a fingerprint.

19. The method of claim 17, wherein the biometric print is a portion of a handprint.

20. A method for using a configurable device, comprising;
a. entering configuration information into a configurable device;
b. using a biometric print device coupled to the configurable device to send a biometric print to a party for identity verification; and
c. using the configurable device after it has been configured for use in accordance with a received configuration file.

21. The method of claim 20, wherein the configurable device is a mobile telephone.

22. The method of claim 20, wherein the configurable device is a human transportation vehicle.

23. The method of claim 20, wherein the biometric print device in step (b) is a piezoelectric identification device.

24. The method of claim 20, wherein the biometric print device in step (b) is a wireless transceiver biometric device.

25. A method for verifying the identity of an individual prior to configuring a configurable device for use by the individual, comprising;
a. receiving biometric print information for an individual wanting to use the configurable device;
b. comparing the received biometric print to one or more stored biometric prints to authenticate the identify of the individual;
c. if the received biometric print matches a stored biometric print associated with the individual, sending data regarding the identity of the individual to a party who controls configuration of the configurable device.

26. The method of claim 25, wherein the configurable device is a mobile telephone.

27. The method of claim 25, wherein the configurable device is a human transportation vehicle.

28. The method claim 25, wherein the biometric print information being received in step (a) comprises a portion of a biometric print.

29. The method of claim 25, further comprising;
d. generating audit information based on the results of said step (b); and
e. storing the audit information.

30. A biometric authentication-enabled system, comprising;
a biometric print device; and
a configurable device that is coupled to said biometric print device and may be configured based on biometric information about a user of said configurable device captured by said biometric print device.

31. The biometric authentication-enabled system of claim 30, wherein said biometric print device is a piezoelectric identification device.

32. The biometric authentication-enabled system of claim 30, wherein said biometric print device is a wireless biometric transceiver device.

33. The configurable device of claim 30, wherein said configurable device is a mobile telephone.

34. The configurable device of claim 30, wherein said configurable device is a human transportation vehicle.
